(19) United States
(12) Patent Application Publication
(10) Pub. No.: US 2010/0294728 A1
(43) Pub. Date: Nov. 25, 2010

(54) PREPARATION OF NANOSIZED COMPOUND ZNO/SNO2 PHOTOCATALYSTS

(76) Inventor: Leila Asgharnejad, Tehran (IR)

Correspondence Address: CHOOBIN & CHOOBIN CONSULTANCY L.L.C;Barry Choobin, Green Community, Building 3, Ground Floor, Dubai Investment Park, P.O Box 212880, Dubai, AE

(21) Appl. No.: 12/824,259

(22) Filed: Jun. 28, 2010

(51) Int. Cl. C02F 1/32; B01J 23/06; B01J 23/14; B01J 27/04; C02F 1/72; A62D 3/00

(52) U.S. Cl. 210/748.14; 502/343; 502/216; 977/811; 977/773

(57) ABSTRACT

The various embodiments herein provide a method of preparation nanosized amorphous compound ZnO/SnO2 photocatalysts. According to one embodiment herein, the nanosized amorphous compound ZnO/SnO2 photocatalysts are synthesized through coprecipitation method using NaOH as coprecipitant. According to one embodiment herein, nanosized amorphous compound ZnO/SnO2 photocatalysts are synthesized also by another method with molar ratio of 2:1 in ethanol solvent. Nanosized compound ZnO/SnO₂ photocatalysts synthesized are for use in treatment of organic wastes by converting the carcinogenic compounds to harmless compounds. The obtained nanosized compound ZnO/SnO2 photocatalysts are of more equal unit. According to another embodiment, a method of preparation of nanosized compound ZnO/SnO2 photocatalysts wherein the degradation rate constant of the Acid Red 27 (AR27) having a fixed rate of the nominal speed of synthetic photocatalyst is improved by 8 times approximately.

### SPONSORSHIP STATEMENT

The present invention for international filing is sponsored by The Iranian Nanotechnology initiative Council.

### BACKGROUND

1. Technical Field

The embodiments herein generally relates to the field of photocatalysis and particularly to nano-photocatalysis. The present invention particularly relates to the nano-photocatalysts. The present invention more particularly relates to the process of preparation of the nanosized photocatalysts for the treatment of all kinds of organic wastes.

2. Description of the Related Art

In chemistry, photocatalysis is the acceleration of a photoreaction in the presence of a catalyst. In catalysed photolysis, light is absorbed by an adsorbed substrate. In photo generated catalysis, the photo catalytic activity (PCA) depends on the ability of the catalyst to create electron-hole pairs, which generate free radicals (hydroxyl radicals: —OH) able to undergo secondary reactions. Its comprehension has been made possible ever since the discovery of water electrolysis by means of the titanium dioxide. Commercial application of the process is called Advanced Oxidation Process (AOP). There are several methods of achieving AOP's that can but do not necessarily involve TiO2 or even the use of UV light. Generally the defining factor is the production and use of the hydroxyl radical.

The various applications of photocatalysis involves: Conversion of water to hydrogen gas by photocatalytic water splitting. An efficient photocatalyst in the UV range is based on a sodium tantalum oxide NaTaO with co-catalyst nickel oxide. The surface of the sodium tantalum oxide crystals is grooved with so called nano-steps that are a result of doping with lanthanum (3-15 nm range, see nanotechnology). The NiO particles which facilitate hydrogen gas evolution are present on the edges, the oxygen gas evolves from the grooves.

Use of titanium dioxide in self-cleaning glass. Free radicals generated from TiO2 oxidize organic matter.

Disinfection of water by titanium dioxide photocatalysis.

Oxidation of organic contaminants using magnetic particles that are coated with titanium dioxide nano-particles and agitated using a magnetic field while being exposed to UV light.

Conversion of carbon dioxide into gaseous hydrocarbons using titanium dioxide in the presence of water. As an efficient absorber in the UV range, titanium dioxide nano-particles in the anatase and rutile phases are able to generate excitations by promoting electrons across the band gap. The electrons and holes react with the surrounding water vapor to produce hydroxyl radicals and protons. At present, the proposed reaction mechanisms usually suggest the creation of a highly reactive carbon radical from carbon monoxide and carbon dioxide which then reacts with the photo-generated protons to ultimately form methane. Although the efficiencies of present titanium dioxide based photocatalysts are low, the incorporation of carbon based nanostructures such as carbon nanotubes and metallic nanoparticles have been shown to enhance the efficiency of these photocatalysts.

Sterilization of surgical instruments and removal of unwanted fingerprints from sensitive electrical and optical components.

Photocatalysis is a fantastic way to clean facilities, houses and living environments. By modifying and further developing this technology, we can reduce pollution in our air and water. We can even reduce the spread of infections and diseases such as SARS in hospitals. This cleaner way of life would benefit everyone around the world.

The word photocatalysis is composed of two parts: The prefix photo, defined as “light” and Catalysis is the process where a substance participates in modifying the rate of a chemical transformation of the reactants without being altered in the end. This substance is known as the catalyst which increases the rate of a reaction by reducing the activation energy.

Hence, photocatalysis is a reaction which uses light to activate a substance which modifies the rate of a chemical reaction without being involved itself.

Zinc oxide is an inorganic compound with the formula ZnO. It usually appears as a white powder, nearly insoluble in water. The powder is widely used as an additive into numerous materials and products including plastics, ceramics, glass, cement, rubber (e.g., car tires), lubricants,[2] paints, ointments, adhesives, sealants, pigments, foods (source of Zn nutrient), batteries, ferrites, fire retardants, first aid tapes, etc. ZnO is present in the Earth's crust as the mineral zincite; however, most ZnO used commercially is produced synthetically.

The applications of zinc oxide powder are numerous, such as Rubber manufacture, Concrete industry, Medical, Cigarette filters, Food additive, Pigment, Coatings, Corrosion prevention in nuclear reactors. Most applications exploit the reactivity of the oxide as a precursor to other zinc compounds. For material science applications, zinc oxide has high refractive index, high thermal conductivity, binding, antibacterial and UV-protection properties. Consequently, it is added into various materials and products, including plastics, ceramics, glass, cement, rubber, lubricants, paints, ointments, adhesive, sealants, pigments, foods, batteries, ferrites, fire retardants, etc.

The zinc oxide photocatalyst is proved to be useful for removing low concentration nitrogen oxides (NOx gas) in the atmosphere. In addition, it is succeeded to improve the performance by compounding the titanium oxide (NO) as the adsorption material with nitric oxide absorption character rather than the photocatalyst.

Tin (II) oxide (stannous oxide) is a compound of tin and oxygen where tin has the oxidation state of +2. Titanium dioxide, also known as titanium (IV) oxide or Titania, is the naturally occurring oxide of titanium, chemical formula TiO2. When used as a pigment, it is called titanium white, Pigment White 6, or CI 77891. There are two forms, a stable blue-black form and a metastable red form. The dominant use of stannous oxide is as a precursor in manufacturing of other, typically divalent, tin compounds or salts. Stannous oxide may also be employed as a reducing agent and in the creation of ruby glass. It has a minor use as an esterification catalyst.

Tin oxide thin-film electrode is proved to be useful in the photocatalytic activity of nanostructured indium for azo-dye degradation. Its wide range of applications, as a photocatalyst, from paint to sunscreen to food coloring, for which it was given E number E171.

Ethanol, also called ethyl alcohol, pure alcohol, grain alcohol, or drinking alcohol, is a volatile, flammable, colorless liquid. It is a powerful psychoactive drug, best known as the type of alcohol found in alcoholic beverages and in modern thermometers. Ethanol is one of the oldest recreational drugs. In common usage, it is often referred to simply as alcohol or spirits.

Ethanol has widespread use as a solvent of substances intended for human contact or consumption, including scents, flavorings, colorings, and medicines. In chemistry, it is both an essential solvent and a feedstock for the synthesis of other products. It has a long history as a fuel for heat and light, and more recently as a fuel for internal combustion engines.

Azo dyes are synthetic colors that contain an azo group, —N═N—, as part of the structure. Azo groups do not occur naturally. Most azo dyes contain only one azo group, but some contain two (diazo), three (triazo) or more.

Azo dyes account for approximately 60-70% of all dyes used in food and textile manufacture. In theory, azo dyes can supply a complete rainbow of colors, but yellow/red dyes are more common as blue/brown dyes.

The acute toxicity of azo dyes, as defined by the EU criteria for classification of dangerous substances, is rather low. Direct toxic levels of azo dyes will never be reached by consuming azo dye colored food. The majority of azo dyes (food and textile) have LD50 values between 250-2,000 mg/kg body weight, indicating that for a lethal dose many grams of azo dyes have to be consumed in a single dose. As azo dyes are highly water soluble, they do not accumulate in the body, but are metabolized in the liver and excreted in the urine. As azo dyes are very strong color, foods normally are colored with dyes in levels of mg dye/kg food. To reach a lethal dose an average adult person thus need to consume over 100 kg of azo colored food in a single day.

Nevertheless some azo dyes have been banned for food use due to toxic side effects. These are not due to the dye itself, but to degradation products of the dyes. It has been recognized that some azo coloring agents may form amines (breakdown products), which have carcinogenic and mutagenic properties. Therefore the EU has restricted the use of certain azo dyes.

Removal of organic compounds existing in wastewaters has always been one of the prominent problems. From among such compounds, azo dyes cover biggest range of commercial dyes. Azo dyes hold one or more of azo Groups (—N═N—) in their structure. These dyes, for simplicity of the synthesis of azo, diazo, and polyazo dyes and for their extended application, allot the greatest cluster of chemical materials to themselves in terms of quantity and production rate. Acidic dyes are one of the azo dyes. These compounds are not acidic in fact but they are salts with strong acid sulfonic groups. Commercial acidic dyes include one or several groups of —SO3Na are solved in aquatic environments. Generally, these dyes are used in the presence of mineral or organic acids. A big cluster among acidic dyes is red acidic dyes. Production rate of red acidic dyes in 1975 in USA was 1378 tons. Monoazo and diazo compose most members of this group. The studied pollutant subject to this project is Acid Red 27 (AR27) from monoazo group is one of acidic dyes solved in water. Azo dyes compose a big group of vigorous and biologically non-destructible pollutants of water. Azo dyes and compounds derived from them are known as carcinogen compounds. Increased anxiety of the public about such compounds and fastidiousness of international environmental standards (ISO 14001) has made researchers to develop new treatment methods for converting these dyes to harmless compounds. Acid Red 27 (AR27) is used as a food dyes, textile dye for coloring wool and silk. In 1970, Russian scientists proved that Acid Red 27 (AR27) is a carcinogen compound. Specifications of this material are presented in Table 3.

Hence there is a need for an efficient and a prompt method for preparation of nanosized compound ZnO/SnO₂ photocatalysts for the removal of organic wastes.

The above mentioned shortcomings, disadvantages and problems are addressed herein and which will be understood by reading and studying the following specification.

### OBJECTIVES OF THE INVENTION

The primary object of the embodiments herein is to provide a method of preparation of nanosized compound ZnO/SnO₂ photocatalysts.

Another object of the embodiments herein is to provide a method of preparation of nanosized compound ZnO/SnO₂ photocatalysts through coprecipitaion method using NaOH as coprecipitant.

Another object of the embodiments herein is to provide a method of preparation of nanosized compound ZnO/SnO₂ photocatalysts with molar ratio of 2:1 in ethanol solvent.

Another object of the embodiments herein is to provide a method of preparation of nanosized compound ZnO/SnO₂ photocatalysts for use in treatment of organic wastes.

Another object of the embodiments herein is to provide a method of preparation of nanosized compound ZnO/SnO₂ photocatalysts for converting the carcinogenic compounds to harmless compounds.

Another object of the embodiments herein is to provide a method of preparation of nanosized compound ZnO/SnO₂ photocatalysts having amorphous form at a temperature of 300° C.

Another object of the embodiments herein is to provide a method of preparation of nanosized compound ZnO/SnO₂ photocatalysts, wherein the particles obtained hereof intense compilation due to superfine nature.

Another object of the embodiments herein is to provide a method of preparation of nanosized compound ZnO/SnO₂ photocatalysts wherein the particles obtained are of more equal unit.

Another object of the embodiments herein is to provide a method of preparation of nanosized compound ZnO/SnO₂ photocatalysts wherein the degradation rate constant of the Acid Red 27 (AR27) having a fixed rate of the nominal speed of synthetic photocatalyst is improved by 8 times approximately.

These and other objects and advantages of the embodiments herein will become readily apparent from the following detailed description taken in conjunction with the accompanying drawings.

### SUMMARY

The various embodiments herein provide a process of preparing nano-sized compound photo-catalysts for the treatment of organic wastes. The process comprises selecting a compound from a group of oxides, wherein the compound selected is a zinc oxide (ZnO) and a stannous oxide (SnO2). A raw material of the oxides is poured into an erlen with a preset molar ratio of 20:1, 2:1, 1:1, 1:2 and 1:20, wherein the raw material for zinc oxide (ZnO) is ZnSO4.7H2O and the raw material for stannous oxide (SnO₂) is SnCl₄.5H₂O. The raw material is dissolved in the erlen with a preset quantity of distilled water to obtain a solution. The obtained solution of raw material and distilled water is mixed using a mixer. 4 mol l⁻¹ of NaOH is added drop by drop to the solution till a white sediment is precipitated, wherein NaOH is used as a co-precipitant. NaOH is added continuously to the solution till the pH of the solution reaches 7. The pH controlled solution is mixed in a mixer, after the precipitation of the white sediment to acquire a resultant solution. The resultant solution is passed through a filter to obtain a resultant sediment. The resultant sediment is dried in an oven under temperature of 100° C. to obtain a nano-photo-catalyst. The obtained nano-photo-catalyst is transferred to a Krause. The nano-photo catalyst is calcinated under preset temperatures for 3 hours in a furnace. The effect of calcination time is analyzed with respect to the size of the synthetic nano-particles.

According to one embodiment, a compound nano-photo catalyst is synthesized by the same process, wherein the compound nano-photo catalyst is a Z₂S containing a zinc (Zn) and a stannous (Sn) in a molar ratio 2:1. According to one embodiment, a composition comprises of a compound belonging to a group of oxides namely the zinc oxide (ZnO) and stannous oxide (SnO₂) as the base material of the photo-catalysts. The nano sized photo catalyst of ZnO and SnO₂ prepared through the co-precipitation process using NaOH as co-precipitant or ethanol as a solvent is used in the treatment of organic compounds such as the Azo dyes present in wastewaters more efficiently.

According to one embodiment herein, a process is provided for preparing a nano-sized compound photo catalyst for the treatment of organic wastes. The method comprises selecting a compound wherein the compound selected from a group of oxides is a zinc oxide (ZnO) and a stannous oxide (SnO₂). 2.52 g oxalic acid (H₂C₂O₄.2H₂O) is dissolved in 20 ml ethanol to form a first solution in a first erlen under temperature of 50° C. 1.1 g zinc acetate (Zn (CH₃COO)_{2.2H2O}) is mixed along with 30 ml ethanol to form a second solution in a second erlen. The second solution in the second erlen is maintained inside an ultrasonic bath under a temperature of 60° C. A raw material of an oxide is dissolved in ethanol in a third erlen to form a third solution wherein the raw material for zinc oxide (ZnO) is ZnSO₄.7H₂O with a molar ratio of 2:1 and the raw material for stannous oxide (SnO₂) is SnCl₄.5H₂O with a molar ratio of 2:1. The third solution from the third erlen is transferred to the second erlen to mix with the second solution in the second erlen to obtain a resultant solution. The resultant solution is mixed intensely in the second erlen under an ultrasonic wave to obtain a final solution. The final solution is added to the first solution in the first erlen drop by drop to obtain a white gel. The white gel is dried in an oven under a temperature of 80° C. for 20 hours to obtain a sediment which is precipitated. The precipitated sediment is filtered and calcinated for 2 hours under preset temperatures.

According to one embodiment herein, a method of treatment of waste waters comprises synthesizing a nano sized-compound photo catalyst. The synthesized nano-sized compound photo catalyst is mixed with a waste water to be treated wherein the synthesized nano-sized compound photo catalyst acts as a sensor to detect a contaminant in the waste water and to destroy the contaminant in the waste water. The detection process and the destruction process of the contaminant in the waste water are performed simultaneously.

The synthesized nano sized compound photo catalyst detects and removes a compound contaminant selected from a group of chemicals containing organic compounds existing with waste waters. The synthesized nano sized compound photo-catalyst is prepared using NaOH as a co-precipitant or using ethanol as a solvent.

The compound contaminant selected from a group of chemicals containing organic compounds is a carcinogenic compound containing Azo dyes. The carcinogenic compound containing Azo dyes is an Acid Red 27 (AR27). The synthesized photo catalyst converts the dyes containing the Azo dyes into harmless compounds.

According to one embodiment herein, the fixed rate of the nominal speed of synthetic photo catalyst is improved by 8 times approximately.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1. illustrates a flow chart explaining the process of preparing nanosized Compound ZnO/SnO2 photo catalysts through a co-precipitation method using NaOH as coprecipitant (1^{st} Method) according to one embodiment herein.

FIG. 2. illustrates a flow chart explaining the process of preparing of nanosized Compound ZnO/SnO2 photocatalysts with Molar Ratio of 2:1 in Ethanol Solvent (2^{nd} Method) according to one embodiment herein.

FIG. 3. illustrates XRD pattern of the coupled ZnO/SnO2 photocatalyst (1^{st} method) calcined at 300° C. for 3 h according to one embodiment herein.

FIG. 4. illustrates XRD pattern of the coupled ZnO/SnO2 photocatalyst (1^{st} method) calcined at 500° C. for 3 h according to one embodiment herein.

FIG. 5. illustrates XRD pattern of the coupled ZnO/SnO2 photocatalyst (1^{st} method) calcined at 700° C. for 3 h according to one embodiment herein.

FIG. 6. illustrates XRD pattern of the coupled ZnO/SnO2 photocatalyst (1^{st} method) calcined at 900° C. for 3 h according to one embodiment herein.

FIG. 7. illustrates XRD illustrates pattern of the coupled ZnO/SnO2 photocatalyst (2^{nd} method) calcined at 500° C. for 2 h according to one embodiment herein.

FIG. 8. illustrates SEM micrograph of the coupled ZnO/SnO2 photocatalyst (1^{st} method) calcined at 300° C. for 3 h according to one embodiment herein.

FIG. 9. illustrates SEM micrograph of the coupled ZnO/SnO2 photocatalyst (1^{st} method) calcined at 500° C. for 3 h according to one embodiment herein.

FIG. 10. illustrates SEM micrograph of the coupled ZnO/SnO2 photocatalyst (1^{st} method) calcined at 700° C. for 3 h according to one embodiment herein.

FIG. 11. illustrates SEM micrograph of the coupled ZnO/SnO2 photocatalyst (1^{st} method) calcined at 900° C. for 3 h according to one embodiment herein.

FIG. 12. illustrates SEM micrograph of the coupled ZnO/SnO2 photocatalyst (2^{nd} method) calcined at 500° C. for 2 h according to one embodiment herein.

FIG. 13. illustrates UV-Vis Spectra of AR27 Solution according to one embodiment herein.

FIG. 14. illustrates Calibration diagram of AR27 solution in λₘₐₓ=522 nm according to one embodiment herein.

FIG. 15. illustrates Comparison of the photocatalytic activity of different photocatalysts at degradation of AR27; [AR27]₀=20 mg l⁻¹, [photocatalyst]=400 mg l⁻¹, I₀=15.5 W m⁻² according to one embodiment herein.

FIG. 16. illustrates Comparison of the removal percent of different photocatalysts at degradation of AR27; [AR27]₀=20 mg l⁻¹, [photocatalyst]=400 mg l⁻¹, I₀=15.5 W m⁻² according to one embodiment herein.

FIG. 17. illustrates Determination of the photocatalytic reaction rate constant (kₐₚ) by linear regression. [AR27]₀=20 mg l⁻¹, [photocatalyst]=400 mg l⁻¹, I₀=15.5 W m⁻² according to one embodiment herein.

FIG. 18. illustrates Comparison of degradation rate constant (kap) of AR27 with different photocatalysts [AR27]₀=20 mg l⁻¹, [photocatalyst]=400 mg l⁻¹, I₀=15.5 W m⁻² according to one embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method of preparation of nanosized compound ZnO/SnO₂ photocatalysts.

According to one embodiment herein, a method is provided for the preparation of nano sized compound ZnO/SnO₂ photo-catalysts through co-precipitation method using NaOH as coprecipitant.

According to another embodiment of the present invention, a method is provided for the preparation of the nano sized compound ZnO/SnO₂ photo-catalysts through co-precipitation method using NaOH as coprecipitant (1^{st} method). The method involves pouring ZnSO₄.7H₂O and SnCl₄.5H₂O with molar ratios of 20:1, 2:1, 1:1, 1:2 and 1:20 in 250 ml erlens and solving it in least quantity of distilled water (Table 1). Mixing the material contained in the test tube using mixer, then adding 4 mol l⁻¹ NaOH to it drop by drop until white fine units emerge gradually. The pH of the solution is measured with a pH meter and NaOH is added continuously until the pH reaches 7 and a composition of the formless white sediment is obtained. Then the acquired material is put over a mixer for 1 hour and then passing it through a filter. The resultant sediment is heated in an oven under a temperature of 100° C. to dry completely to acquire the ZnO/SnO₂ nano-photocatalysts. The acquired material is put inside a Krause and calcinated for 3 hours under different temperatures in a furnace. Furthermore, Z₂S₁ compound nano-photo catalyst is synthesized in the same method and calcinated under a temperature of 500° C. at different times for analyzing the effect of calcination time with respect to the size of the synthetic nano-particles. The ZnO and SnO₂ nano-particles are prepared in the same style with the only difference being the raw material. For preparing ZnO, ZnSO4.7H2O is used as the raw material and for preparing SnO2 SnCl₄.5H₂O is used as the raw material.

TABLE 1
Molar ratios of ZnSO₄•7H₂O and
SnCl₄•5H₂O for preparation of Compound
ZnO/SnO₂ photocatalysts

| Zn/Sn molar ratios | Sn content (mol %) | Sample |
|---|---|---|
| 20:1 | 4.8 | Z₂₀S₁ |
| 2:1 | 33.3 | Z₂S₁ |
| 1:1 | 50 | Z₁S₁ |
| 1:2 | 66.7 | Z₁S₂ |
| 1:20 | 95.2 | Z₁S₂₀ |

According to one embodiment herein, a method is provided for preparing nano sized Compound ZnO/SnO2 photo catalysts with molar ratio of 2:1 in ethanol solvent (2^{nd} method). The method involves dissolving 2.52 g of oxalic acid (H₂C₂O₄.2H₂O) in 20 ml of ethanol in erlen no. 1, under a temperature of 50° C. Then 1.1 g of zinc acetate (Zn(CH3COO)₂.2H₂O) is poured along with 30 ml of ethanol in erlen no. 2 and contents inside the erlen is kept in an ultrasonic bath under a temperature of 60° C. 1.395 g of SnCl₄.5H₂O is dissolved along with 10 ml of ethanol in erlen no. 3. Then the prepared solution is transferred to erlen no. 2 and mixed intensely under the ultrasonic waves. The contents of erlen no. 2 are added drop by drop to a solution in erlen no. 1 to obtain a white gel. The acquired gel is kept inside an oven under a temperature of 80° C. for 20 hours for drying and then the dried sediment is calcinated under different temperatures for 2 hours.

The embodiments herein are related to nanosized photocatalysts namely ZnO/SnO₂.

### Characterization of Photocatalyst

### Study of the Crystal Structure and Size of Synthesized Compound Photocatalysts

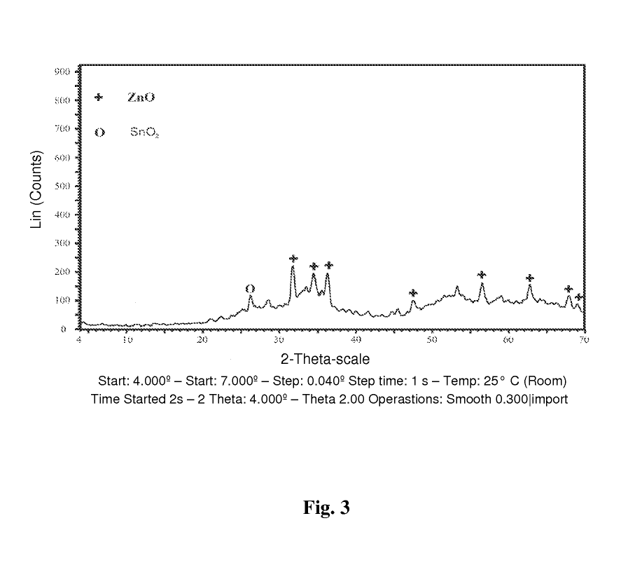

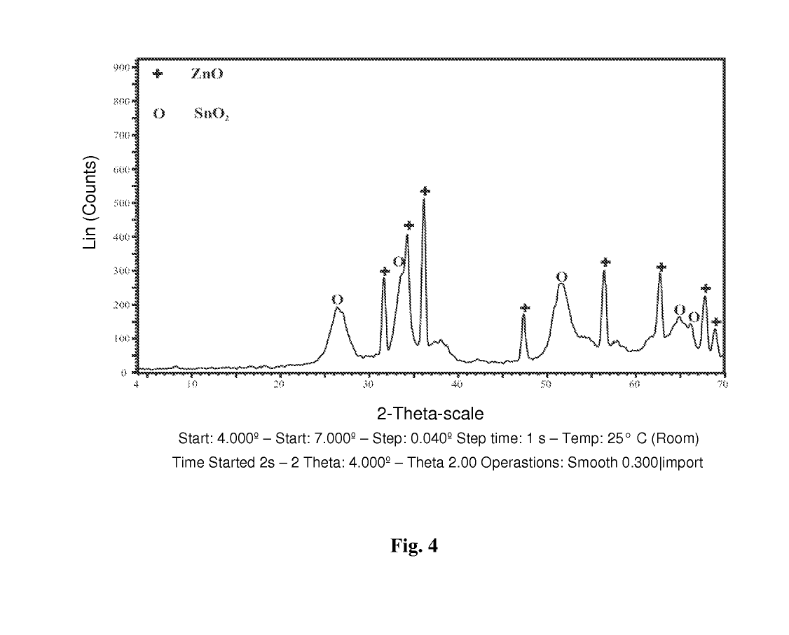

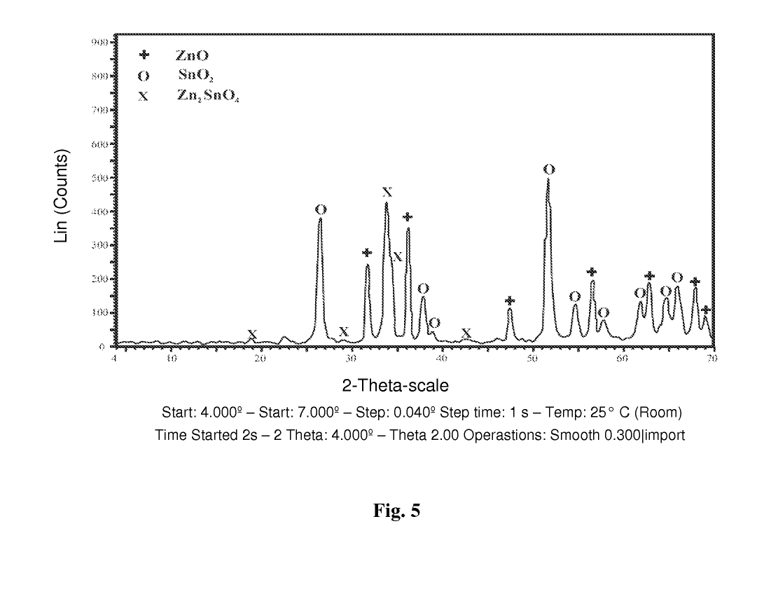

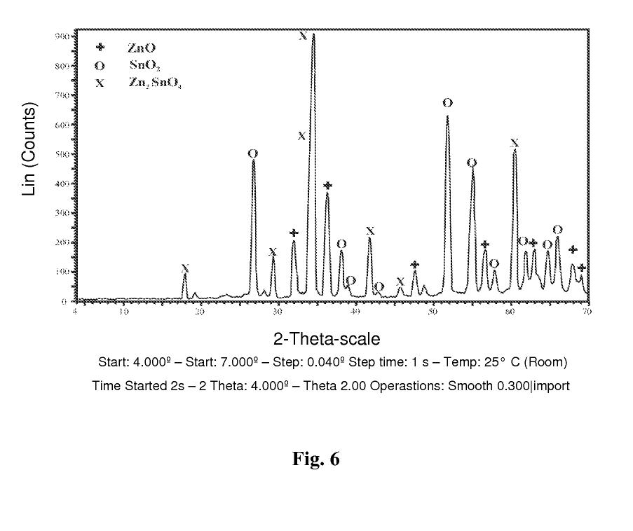

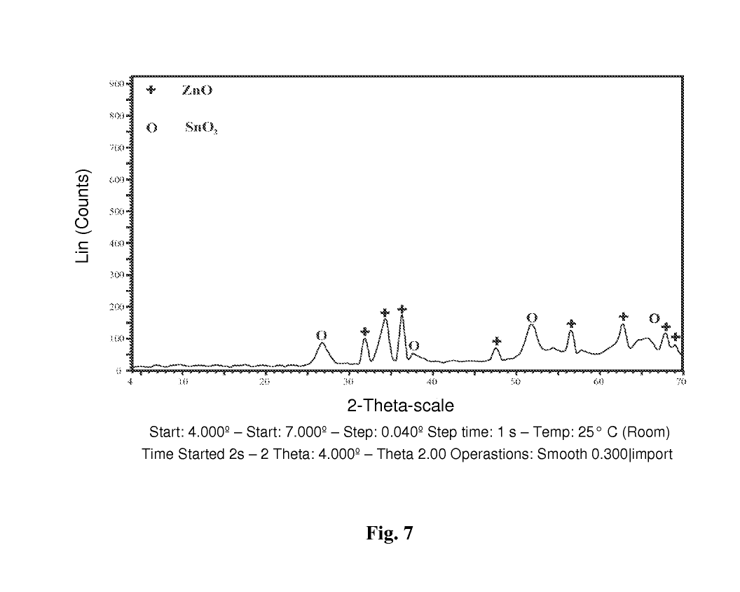

XRD spectra of Z₂S₁ coupled oxides calcinated under different temperatures are represented in FIGS. 3-7. Phases and scale of synthesized photocatalyst particles are represented in Table 1. Size of particles was calculated using Debeye-Scherrer formula.

Considering XRD Spectra, it may be concluded that constituent phases in temperatures of 300° C. and 500° C. included ZnO and SnO₂. But in temperatures of 700° C. and 900° C., besides ZnO and SnO₂ phases another new phase under name of Zn₂SnO₄ was also observed.

This is to be said that in temperatures over 700° C., ZnO and SnO₂ showed reflection to each other, result of which was a composition of Zn₂SnO₄. Interaction between ZnO and SnO₂ for the composition of Zn₂SnO₄ follows:

2ZnO+SnO₂→Zn₂SnO₄

According to FIG. 3, it was concluded that ZnO and SnO nano-particles are of amorphous form under temperature of 300° C. Analysis of the diameter of particles in Table 1 represents that average grain size of Zn₂SnO₄ particles is always bigger than that of ZnO and SnO₂ in the same temperature.

Mean grain size of SnO₂ particles was increased with the increase of temperature while in case of ZnO opposite of this was witnessed. Maybe the presence of SnO₂ particles beside ZnO avoided their full growth.

Therefore, growth mechanism of SnO₂ particles follows surface issuance and SnO₂ particles when placed over ZnO surface avoids them to grow up.

TABLE 2
Relationship of phase, mean grain size and calcinations temperature

| | Calcination | |
|---|---|---|
| | temperature | |
| Sample size | (° C.)/Time (h) | Phase/mean grain |
| Z₂S₁ (1^{st} method) | 300/3 | ZnO/amorphous |
| | | SnO₂/amorphous |
| Z₂S₁ (1^{st} method) | 500/3 | ZnO/14.6 |
| | | SnO₂/3.8 |
| Z₂S₁ (1^{st} method) | 700/3 | ZnO/14.0 |
| | | SnO₂/11.6 |
| | | Zn₂SnO₄/15.6 |
| Z₂S₁ (1^{st} method) | 900/3 | ZnO/11.8 |
| | | SnO₂/13.7 |
| | | Zn₂SnO₄/17.4 |
| Z₂S₁ (2^{nd} method) | 500/2 | ZnO/9.6 |
| | | SnO₂/5.1 |

### Analysis of the Morphology of Synthesized Compound Photocatalysts

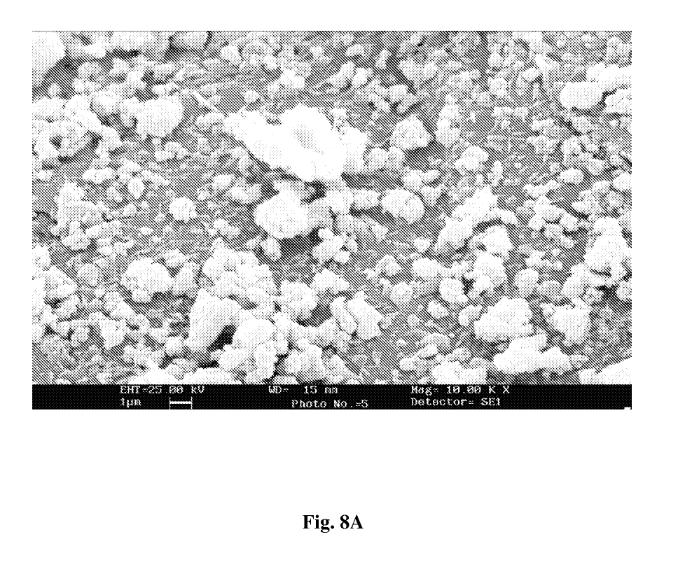

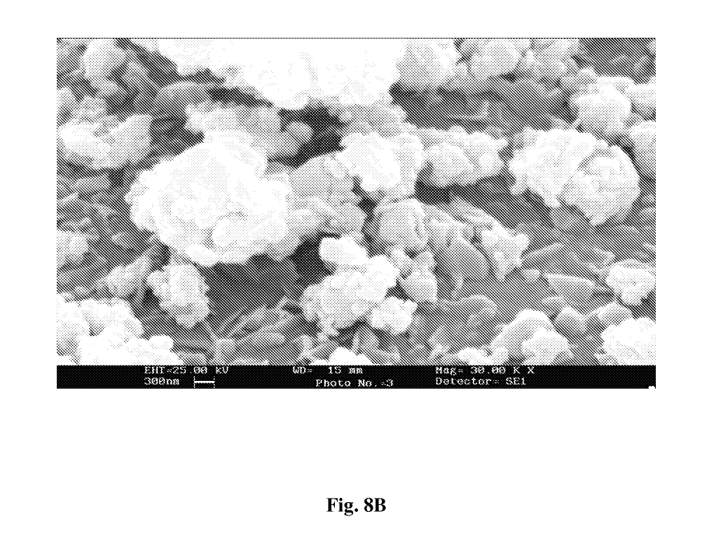

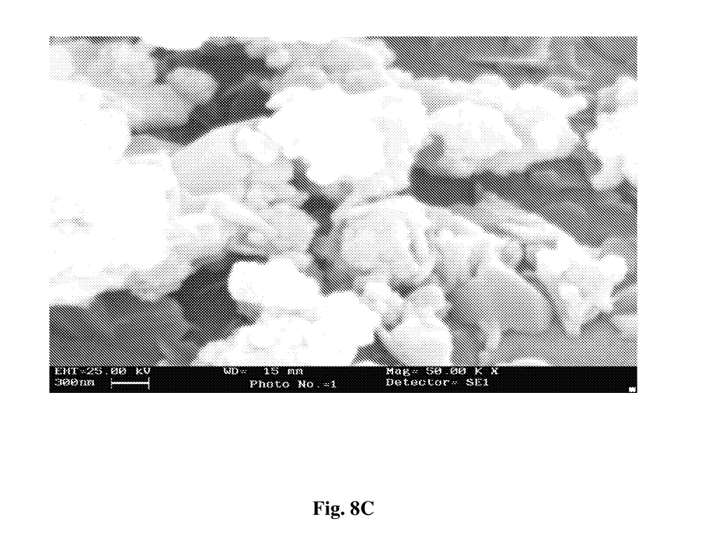

SEM figures of nano-particles synthesized under different conditions are represented in FIGS. 8 to 12. SEM figures indicate that the provided photocatalysts are in nano scales and this confirms results of XRD Spectra.

SEM figures related to Z₂S₁ photocatalyst synthesized through 1^{st} method are represented in different temperatures through FIGS. 8 to 11. Analysis of these figures shows that as it was represented by XRD Spectrum (FIG. 3) phases are in the form of amorphous in temperature of 300° C. (FIG. 8).

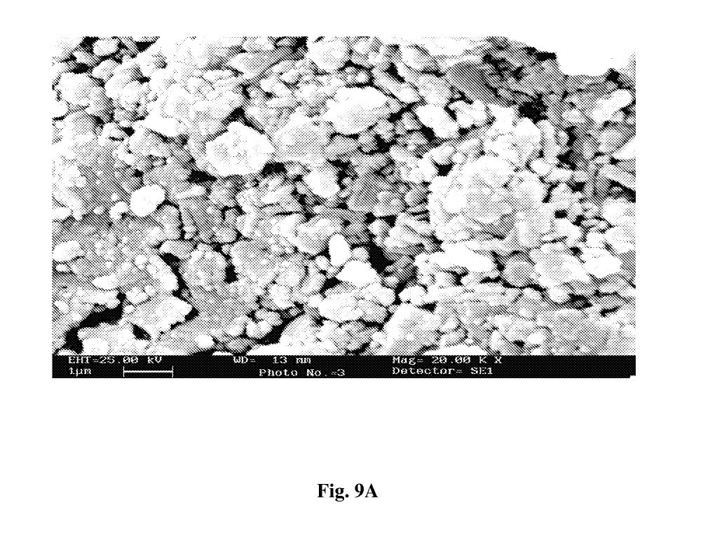

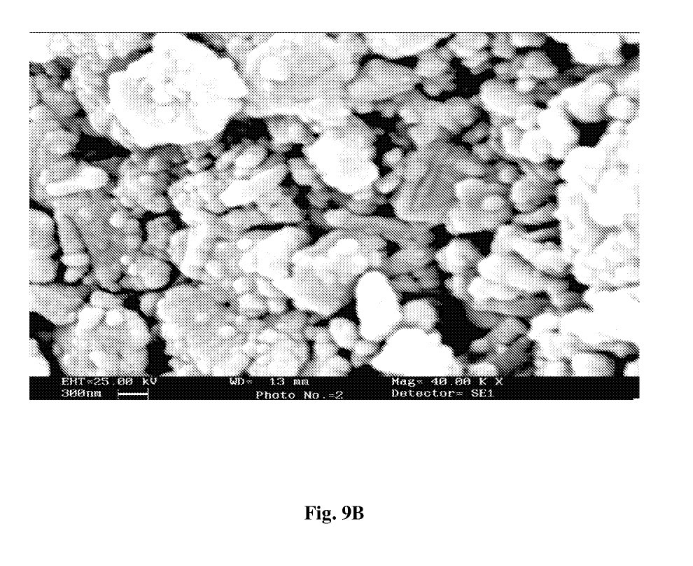

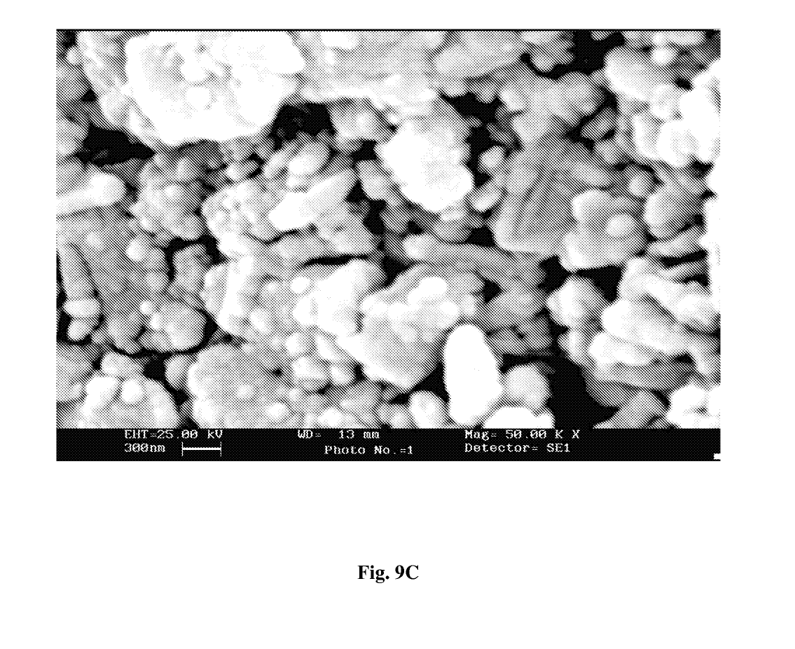

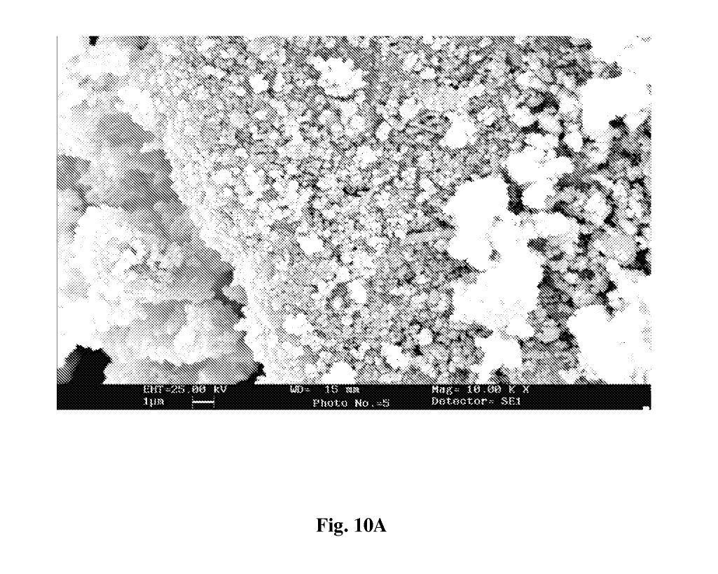

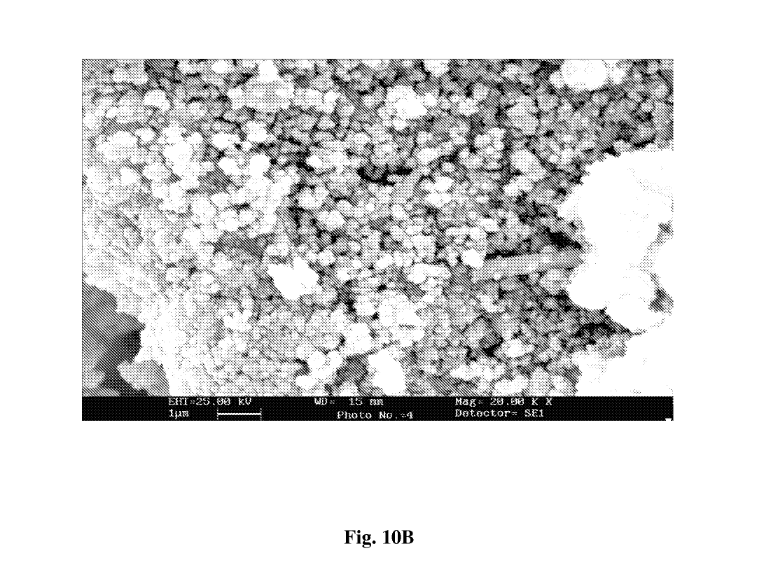

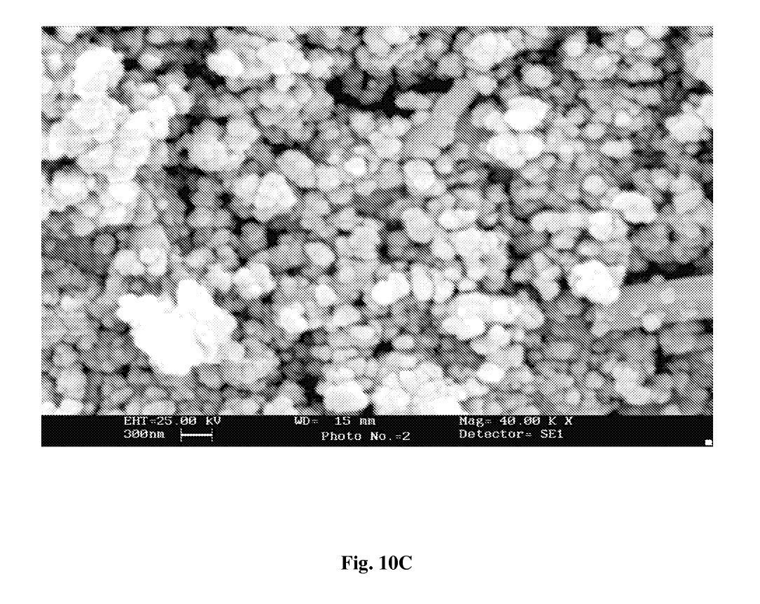

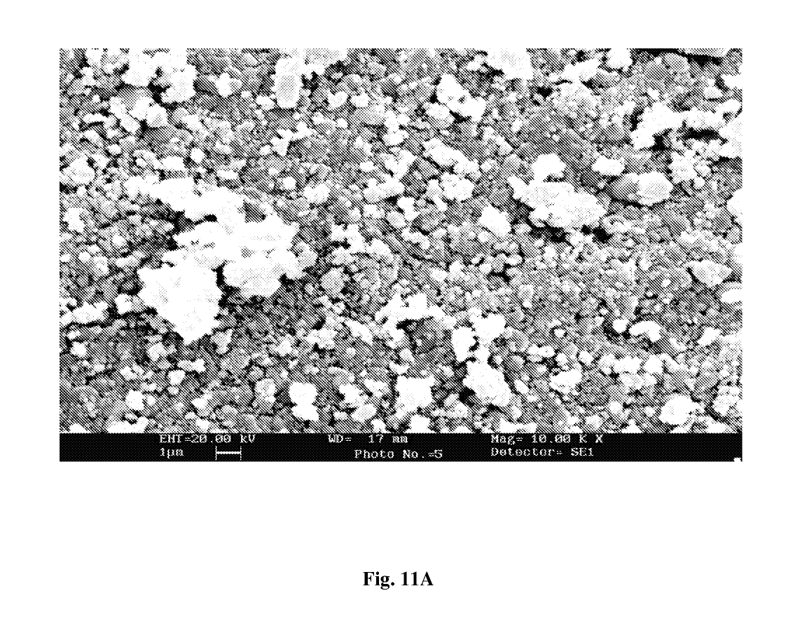

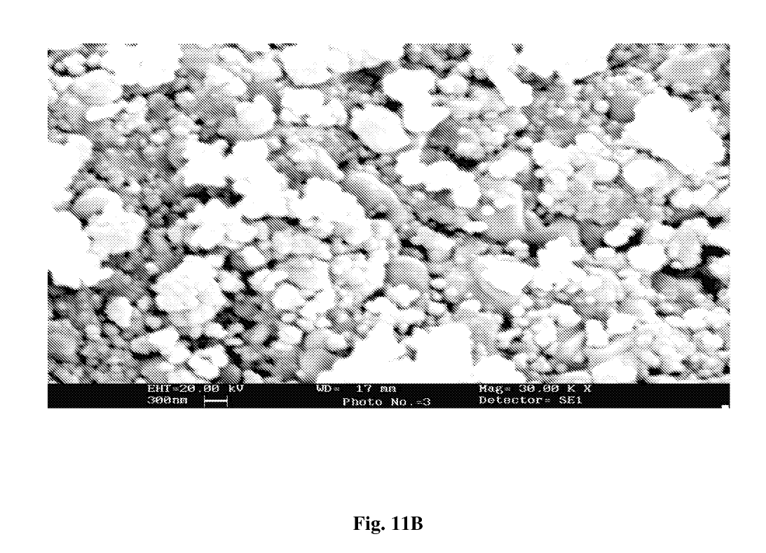

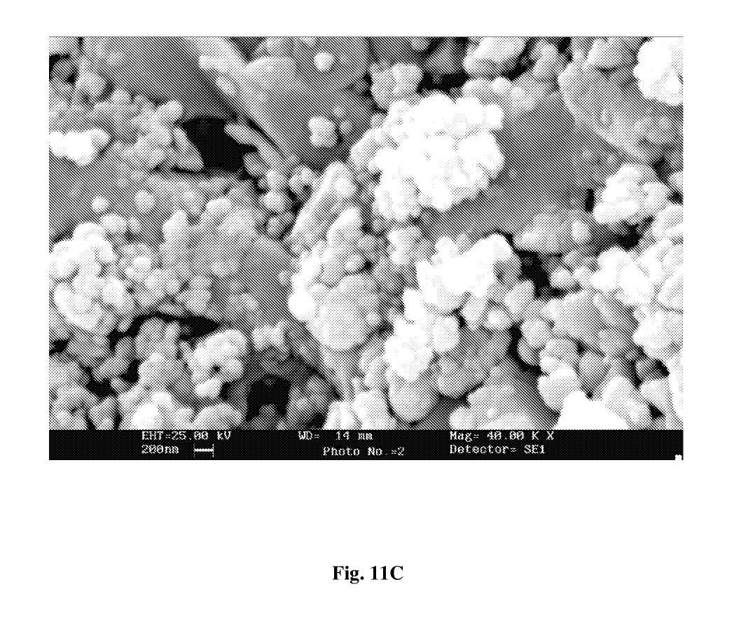

Meantime, intense compilation of particles was observed in this temperature and this was probably because of superfine nature of oxidized particles, especially SnO₂ particles, and higher surface energy in this temperature. In temperature of 500° C., particles were grown and they were not in the form of amorphous anymore but still some compilation was observed (FIG. 9) and in temperatures of 700° C. and 900° C., crystals were released and particles assumed more equal forms in terms of their grading (FIGS. 10 and 11).

Reason of equal grading of particles under temperatures of 700° C. may lie in the fact that considering Table 1, diameter of the constituent phases in this temperature is close to each other compared to other temperatures.

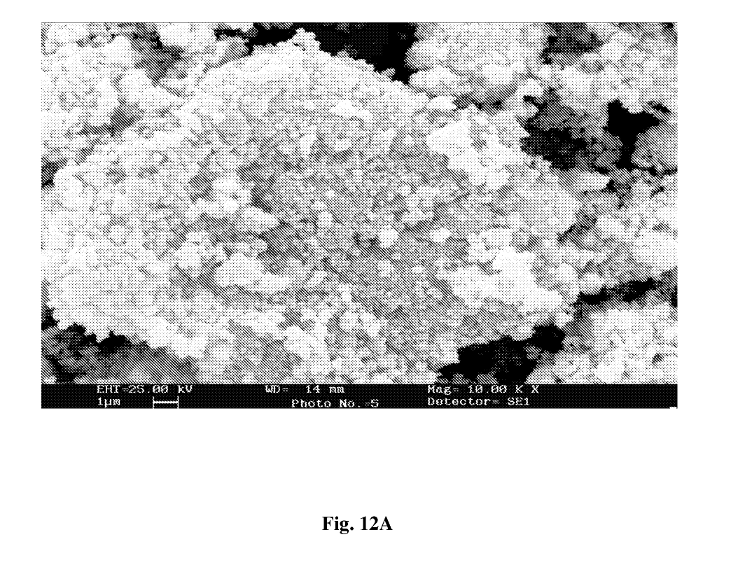

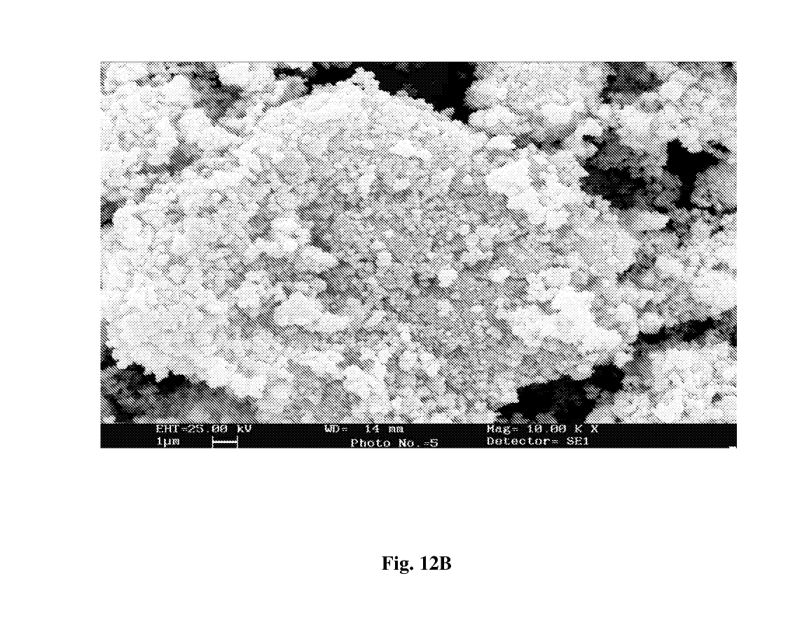

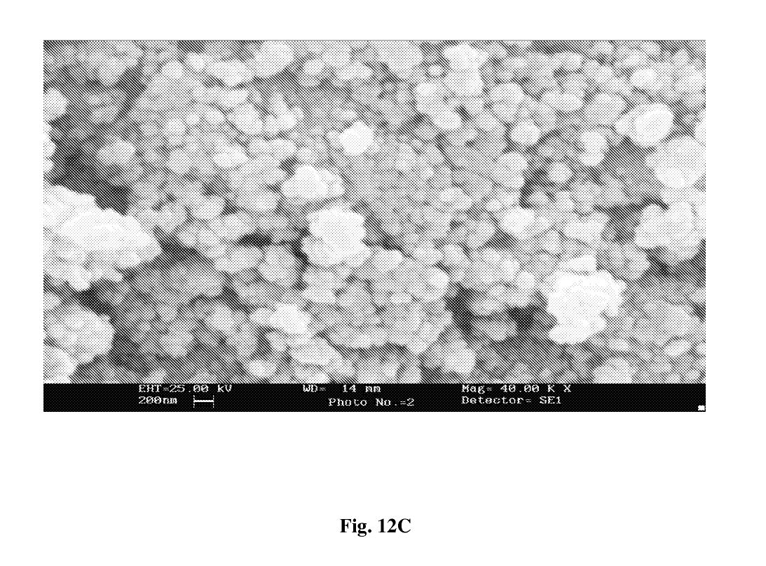

In general, it may conclude from SEM figures that particles synthesized through 2^{nd} Approach (FIG. 12) have more equal units than particles synthesized through 1^{st} method that is because of fineness of the diameter of constituent particles (Table 1).

### Photocatalytic Activity

### Specifications of the Pollutant

Removal of organic compounds existing with wastewaters has always been one of the prominent problems. From among such compounds, azo dyes cover biggest range of commercial dyes.

Azo dyes hold one or more of azo Groups (—N═N—) in their structure. These dyes, for simplicity of the synthesis of azo, dieazo, and polyazo dyes and for their extended application, allot the greatest cluster of chemical materials to themselves in terms of quantity and production rate. Acidic dyes are one of the azo dyes.

These compounds are not acidic in fact but they are salts with strong acid sulfonic groups. Commercial acidic dyes include one or several groups of —SO3Na are solved in aquatic environments. Generally, these dyes are used in the presence of mineral or organic acids.

A big cluster among acidic dyes is red acidic dyes. Production rate of red acidic dyes in 1975 in USA was 1378 tons. Monoazo and diazo compose most members of this group.

The studied pollutant subject to this project was Acid Red 27 (AR27) from monoazo group. It is one of the acidic dyes solved in water. Azo dyes compose of a big group of vigorous and biologically non-destructible pollutants of water. Azo dyes and compounds derived from them are known as carcinogen compounds. Increased anxiety of the public about such compounds and fastidiousness of international environmental standards (ISO 14001) has made researchers to develop new treatment methods for converting these dyes to harmless compounds. Acid Red 27 (AR27) is used as a food dyes, textile dye for coloring wool and silk. In 1970, Russian scientists proved that Acid Red 27 (AR27) is a carcinogen compound. Specifications of this material are presented in Table 3.

TABLE 3
Structure and characteristics of C.I. Acid Red 27 (AR27)

| Structure | 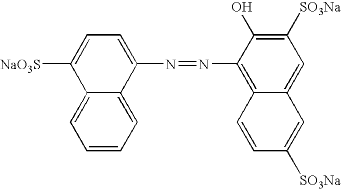 |
|---|---|
| Other names | Amaranth, Azorubin S, FD & C Red 2, |
| | Food Red 9 |
| C.I. number | 16185 |
| λₘₐₓ (nm) | 522 |
| M_{w} (g mol⁻¹) | 604.48 |

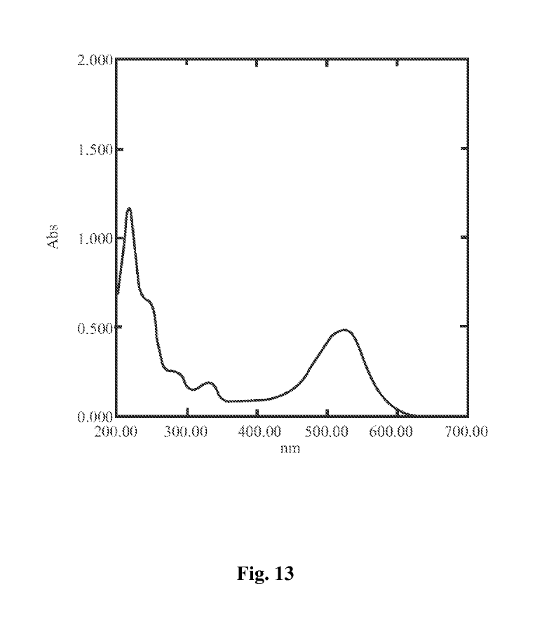

For measurement of the concentration of AR27, absorption characteristics of this material were used in UV-Vis zone. For determination of the maximum absorption wavelength (λmax), the absorption spectrum was drawn through double-beam UV-Vis spectrophotometer in the wavelength range from 200 to 700 nm (FIG. 13). As it is represented in this Fig., the related absorption spectrum represents an intense absorption in wavelength of 522 nm. So this wavelength was selected for measurement of the concentration of AR27.

After determination of the said λₘₐₓ, it was necessary to draw up calibration diagram for the concentration of unknown samples. For this reason, 6 solutions with different concentration of AR27 were prepared according to Table 4 and their absorptions were measured in wavelength of 522 nm as represented in Table 4.

TABLE 4
Absorption data in different initial densities of AR27

| | [AR27] (mg l⁻¹) | | | | | |
|---|---|---|---|---|---|---|
| | 5 | 10 | 20 | 30 | 40 | 50 |
| Absorption | 0.119 | 0.241 | 0.486 | 0.737 | 0.955 | 1.227 |

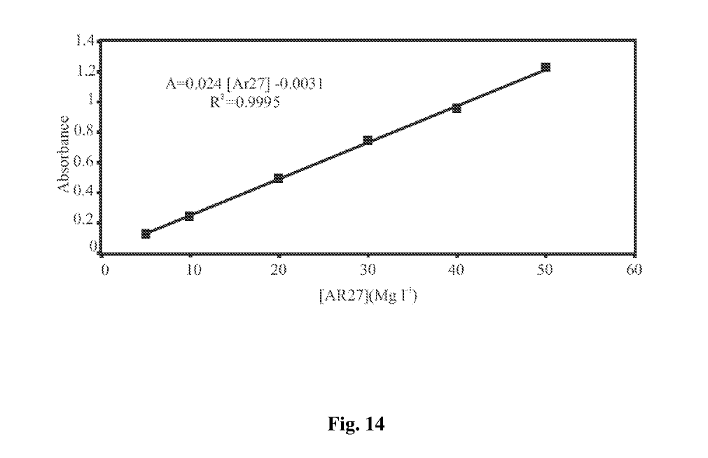

Calibration line was presented, based on the data included in the foregoing table and using linear regression in FIG. 14. Calibration Diagram was used for the sake of other parts of the test for converting the acquired absorption rates to concentration of AR27 material.

The nanosized compound ZnO/SnO₂ photocatalysts synthesized have amorphous form at a temperature of 300° C.

The obtained nanosized compound ZnO/SnO2 photocatalysts have more equal unit.

The nanosized compound ZnO/SnO₂ photocatalysts synthesized are for use in treatment of organic wastes.

The nanosized compound ZnO/SnO₂ photocatalysts synthesized converts the carcinogenic compounds to harmless compounds.

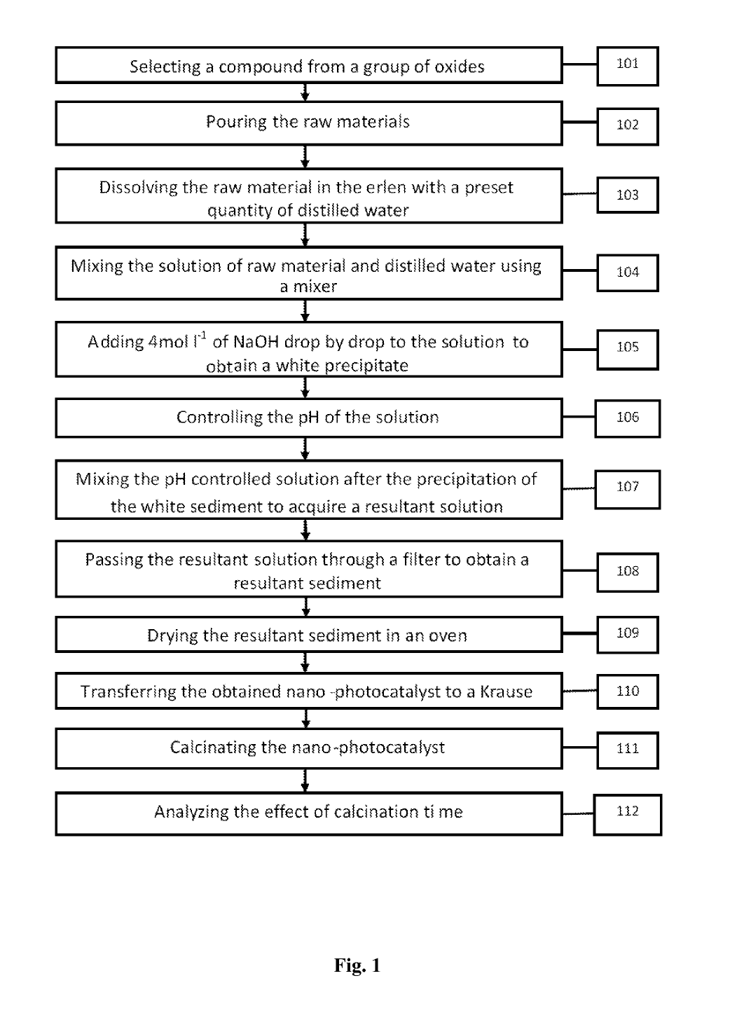

FIG. 1 illustrates a flow chart explaining the process of nano sized compound ZnO/SnO₂ photo catalysts through co-precipitation method using NaOH as co-precipitant according to one embodiment herein. With respect to FIG. 1, the process of preparing nano-sized compound ZnO/SnO₂ photo catalysts for treating organic wastes, involves selecting a compound from a group of oxides wherein the compound selected is a zinc oxide (ZnO) and a stannous oxide (SnO₂) (101). A raw material of the oxides is poured in an erlen with a preset molar ratio of 20:1, 2:1, 1:1, 1:2 and 1:20, wherein the raw material for zinc oxide (ZnO) is ZnSO4.7H2O and the raw material for stannous oxide (SnO2) is SnCl₄.5H₂O (102). The raw material in the erlen is dissolved with a preset quantity of distilled water to obtain a solution (103). The solution of raw material is mixed with distilled water using a mixer (104). 4 mol l⁻¹ of NaOH is added to the solution drop by drop till a white sediment is precipitated wherein NaOH is used as a co-precipitant (105). NaOH is added continuously to the solution till the pH of the solution reaches 7 (106). The pH controlled solution is mixed after the precipitation of the white sediment using a mixer to acquire a resultant solution (107). The resultant solution is passed through a filter to obtain a resultant sediment (108). The resultant sediment is dried in an oven under temperature of 100° C. to obtain a nano-photo catalyst (109). The obtained nano-photo catalyst is transferred to a Krause (110). The nano-photo catalyst is calcinated under preset temperatures for 3 hours in a furnace (111). The effect of calcination time with respect to the size of the synthetic nano-particles is analyzed (112).

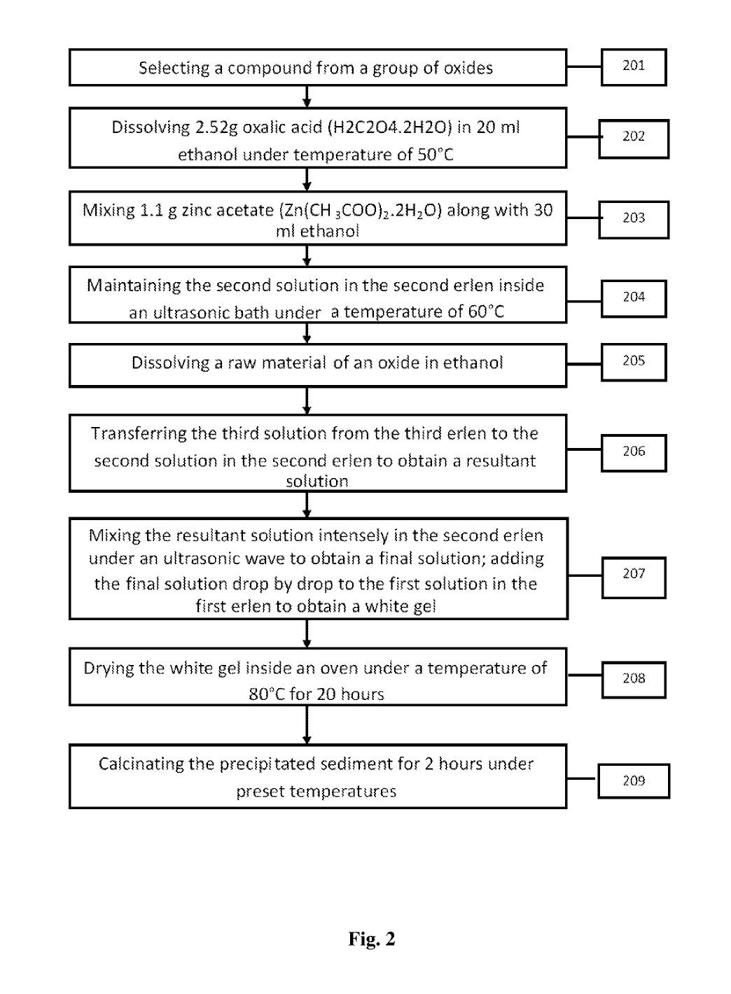

FIG. 2 illustrates a flow chart explaining the process of preparing nano sized compound ZnO/SnO₂ photo catalysts with molar ratio of 2:1 in Ethanol Solvent, according to one embodiment herein. With respect to FIG. 2, a process of preparing nano sized compound ZnO/SnO₂ photo catalysts for treating organic wastes, involves selecting a compound from a group of oxides wherein the compound selected is a zinc oxide (ZnO) and a stannous oxide (SnO₂) (201). 2.52 g oxalic acid (H₂C₂O₄.2H₂O) is dissolved in 20 ml ethanol to form a first solution in a first erlen under temperature of 50° C. (202). 1.1 g zinc acetate (Zn(CH₃COO) 2.2H2O) is mixed along with 30 ml ethanol to form a second solution in a second erlen (203). The second solution in the second erlen maintained inside an ultrasonic bath under a temperature of 60° C. (204). A raw material of an oxide is dissolved in ethanol in a third erlen to form a third solution wherein the raw material for zinc oxide (ZnO) is ZnSO₄.7H₂O with a molar ratio of 2:1 and the raw material for stannous oxide (SnO2) is SnCl₄.5H₂O with a molar ratio of 2:1 (205). The third solution from the third erlen is transferred to the second solution in the second erlen to obtain a resultant solution (206). The resultant solution is mixed intensely in the second erlen under an ultrasonic wave to obtain a final solution. The final solution is added drop by drop to the first solution in the first erlen to obtain a white gel (207). The white gel is dried in an oven under a temperature of 80° C. for 20 hours to obtain a sediment which is precipitated (208). The precipitated sediment is calcinated for 2 hours under preset temperatures (209).

The degradation rate constant of the Acid Red 27 (AR27) having a fixed rate of the nominal speed of synthetic photo catalyst is improved by 8 times approximately.

### Experimental Data

### Study of the Photocatalyst Activity of Oxidized Nano-Particles Synthesized

40 mg of the considered photocatalyst was provided using scale and poured it inside a 100 ml balloon and then added about 50 ml of distilled water to it. The balloon containing photocatalyst was put under ultrasonic waves in an ultrasonic bath for 10 minutes in order to provide photocatalyst suspension. Reaction suspension was provided through adding 10 ml of AR27 mother solution with the density of 200 mg l⁻¹ inside balloon containing photocatalyst and through bulking it. Doing so, the tested suspension contained 20 mg l⁻¹ of AR27 along with 400 mg l⁻¹ of photocatalyst. Foregoing concentrations were kept fixed in all tests.

The input discharge of the reactor system was adjusted by 0.6 ml min⁻¹ approximately and assigned the placement distance of quartz cell against UV source and kept this distance fixed in all tests. 100 ml of photocatalyst suspension and contaminant were poured inside photoreactor. The provided suspension was swirled in dark for 30 minutes by passing oxygen through it, in order to reach adsorption-desorption equilibrium. After it, 5 ml of the provided sample was taken and poured inside the test tube. The sample inside the test tube represented sample in zero (0) radiation time. UV light was turned on. It was turned off and on every 10 minutes. Another 5 ml from the prepared sample was provided. This was continued until the considered time. Then after completion of sampling task, the samples existing within the test tube were centrifuged for 30 minutes inside Centrifuge System in order to separate catalyst particles completely. Absorption of centrifuged samples in wave length of 522 nm was acquired. Using drawn calibration diagram, the density of the remainder AR27 was calculated in samples.

For reactions with the first order kinetics, following relation is presented:

In

$$\frac{C}{{C}_{0}} = - kt$$

where C0 is the initial concentration of AR27, C is the concentration of AR27 after t time and k is the rate constant for photocatalytic reaction. It was observed from In C/C0 curves in terms of irradiation time that reaction of AR27 was reasonably good consistent with the first order kinetic.

Similarly, removal percent of AR27 was calculated through the following formula:

$$Removal percent = \frac{{C}_{0} - C}{{C}_{0}} = \times 100$$

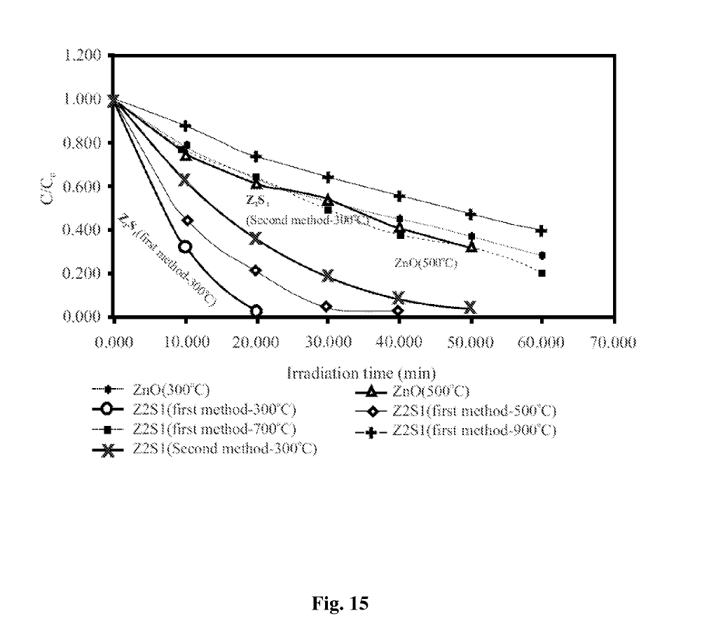

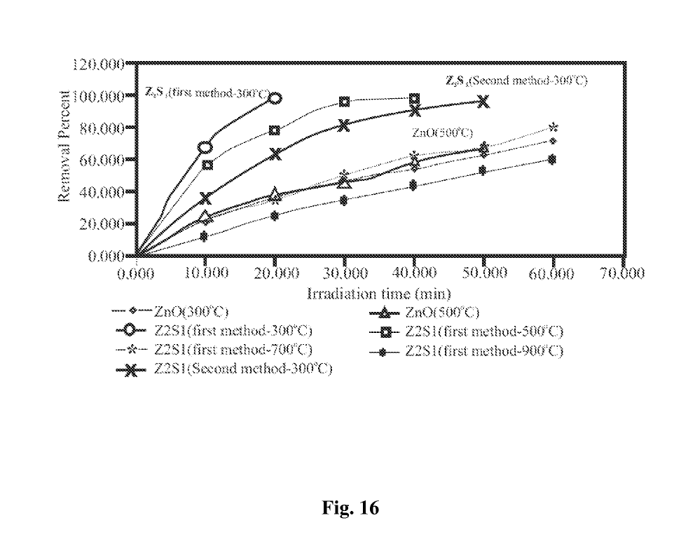

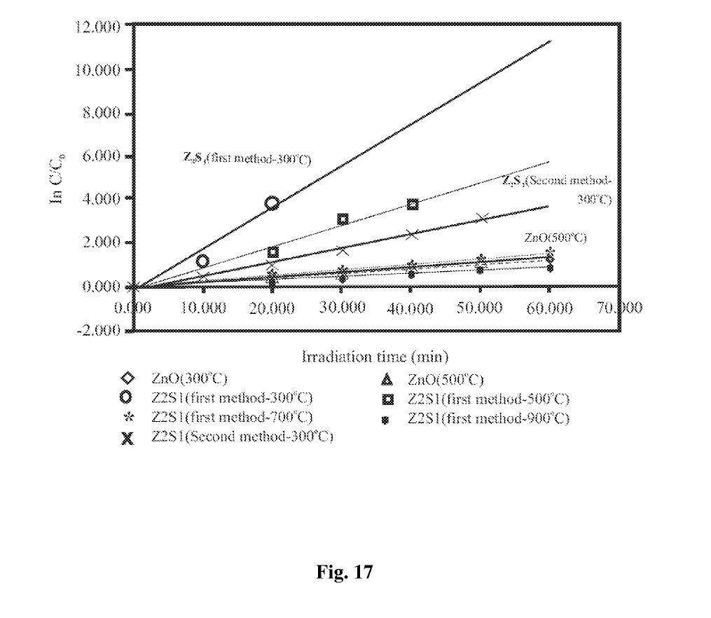

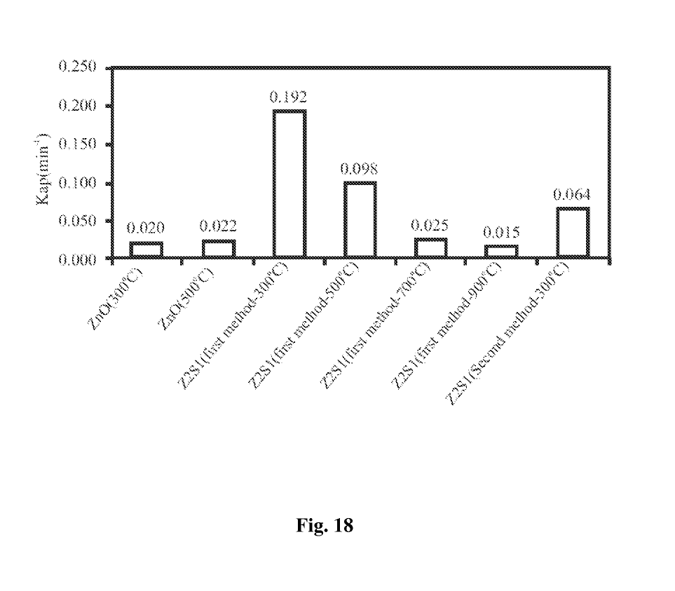

Photocatalyst activity of Z₂S₁ nano-particles (synthetic photocatalyst) and ZnO pure nano-particles provided in different calcination temperatures were tested and the related results are represented in FIGS. 15 to 18. By applying a least square regression analysis the values of k have been obtained (FIG. 17). Table 5 reports the values of k and R (liner correlation coefficient) squared for all experiments carried out.

TABLE 5
Degradation rate constant of AR27 using different photocatalysts

| Photocatalyst | Rate constant (kₐₚ) (min⁻¹) | R² |
|---|---|---|
| ZnO | 0.0201 | 0.9951 |
| ZnO | 0.0219 | 0.9906 |
| Z₂S₁ (1^{st} method, 300° C.) | 0.1921 | 0.9463 |
| Z₂S₁ (1^{st} method, 500° C.) | 0.0978 | 0.9816 |
| Z₂S₁ (1^{st} method, 700° C.) | 0.0252 | 0.9847 |
| Z₂S₁ (1^{st} method, 900° C.) | 0.0152 | 0.9984 |
| Z₂S₁ (2^{nd} method, 300° C.) | 0.0643 | 0.9906 |

As it is represented in Table 5, rate constant of Z₂S₁ synthetic photocatalyst provided through the 1^{st} method and calcinated under temperature of 300° C. was equal to 0.1921 min⁻¹ while rate constant of ZnO calcinated under temperature of 500° C. was equal to 0.0219 min⁻¹.

In other words fixed rate of the nominal speed of synthetic photocatalyst is improved by 8 times approximately.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of preparing a nanosized compound photocatalyst for the treatment of organic wastes, comprises:
selecting a compound from a group of oxides, wherein the compound selected is a zinc oxide (ZnO) and a stannous oxide (SnO₂);
pouring of a raw material of the oxides in an erlen with a preset molar ratio of 20:1, 2:1, 1:1, 1:2 and 1:20, wherein the raw material for zinc oxide (ZnO) is ZnSO₄.7H₂O and the raw material for stannous oxide (SnO₂) is SnCl₄.5H₂O;
dissolving the raw material in the erlen with a preset quantity of distilled water to obtain a solution;
mixing the solution of raw material and distilled water using a mixer;
adding 4 mol l⁻¹ of NaOH drop by drop to the solution till a white sediment is precipitated, wherein NaOH is used as a co-precipitant; adding NaOH continuously to the solution till the pH of the solution reaches 7;
mixing the pH controlled solution after the precipitation of the white sediment using a mixer to acquire a resultant solution;
passing the resultant solution through a filter to obtain a resultant sediment;
drying the resultant sediment in an oven under temperature of 100° C. to obtain a nano-photocatalyst;
transferring the obtained nano-photocatalyst to a Krause;
calcinating the nano-photocatalyst under preset temperatures for 3 hours in a furnace; and
analyzing the effect of calcination time with respect to the size of the synthetic nano-particles.

2. The method according to claim 1, wherein a compound nano-photocatalyst is synthesized by the same process, wherein the compound nano-photocatalyst is a Z₂S₁ containing a zinc (Zn) and a stannous (Sn) in a molar ratio 2:1.

3. The method according to claim 2, wherein the compound nano-photocatalyst is calcinated under temperature of 500° C. at preset times.

4. A method of preparing a nanosized compound photocatalyst for the treatment of organic wastes, comprises:
selecting a compound from a group of oxides, wherein the compound selected is a zinc oxide (ZnO) and a stannous oxide (SnO₂);
dissolving 2.52 g oxalic acid (H₂C₂O₄.2H₂O) in 20 ml ethanol to form a first solution in a first erlen under temperature of 50° C.;
mixing 1.1 g zinc acetate (Zn(CH₃COO)₂.2H₂O) along with 30 ml ethanol to form a second solution in a second erlen;
maintaining the second solution in the second erlen inside an ultrasonic bath under a temperature of 60° C.;
dissolving a raw material of an oxide in ethanol in a third erlen to form a third solution; wherein the raw material for zinc oxide (ZnO) is ZnSO₄.7H₂O with a molar ratio of 2:1; and the raw material for stannous oxide (SnO₂) is SnCl₄.5H₂O with a molar ratio of 2:1;
transferring the third solution from the third erlen to the second solution in the second erlen to obtain a resultant solution;
mixing the resultant solution intensely in the second erlen under an ultrasonic wave to obtain a final solution;
adding the final solution drop by drop to the first solution in the first erlen to obtain a white gel;
drying the white gel inside an oven to obtain a sediment which precipitated under a temperature of 80° C. for 20 hours;
calcinating the precipitated sediment for 2 hours under preset temperatures.

5. The method according to claim 4, wherein 1.395 g of SnCl₄.5H₂O is dissolved along with 10 ml of ethanol in the third erlen to obtain the third solution.

6. A method of treatment of waste waters comprises:
Synthesing a nanosized-compound photocatalyst;
Mixing the synthesized nano-sized compound photocatalyst with a waste water to be treated;
Wherein the synthesized nano-sized compound photo catalyst acts as a sensor to detect a contaminant in the waste water and to destroy the contaminant in the waste water and the detection process and the destruction process of the contaminant in the waste water are performed simultaneously.

7. The method according to claim 6, wherein the synthesized nano sized compound photo catalyst detects and removes a compound contaminant selected from a group of chemicals containing organic compounds existing with waste waters.

8. The method according to claim 6, wherein the synthesized nano sized compound photocatalyst is prepared using NaOH as a co-precipitant.

9. The method according to claim 6, wherein the synthesized nano sized compound photocatalyst is prepared using ethanol as a solvent.

10. The method according to claim 6, wherein the synthesized nano sized compound photocatalyst is a photo catalyst of ZnO.

11. The method according to claim 6, wherein the synthesized nano sized compound photocatalyst is a photo catalyst of SnO₂.

12. The method according to claim 6, wherein the compound selected from a group of chemicals containing organic compounds is a carcinogenic compound containing Azo dyes.

13. The method according to claim 6, wherein the carcinogenic compound containing Azo dyes is an Acid Red 27 (AR27).

14. The method according to claim 6, wherein the synthesized photocatalyst converts the dyes containing the Azo dyes into harmless compounds.

15. The method according to claim 6, wherein the degradation rate constant of AR27 using a synthetic photocatalyst is equal to 0.1921 min⁻¹.

16. The method according to claim 6, wherein the degradation rate constant of AR27 using ZnO photocatalyst calcinated under temperature of 500° C. is equal to 0.0219 min⁻¹.
